(19) United States
(12) Patent Application Publication
(10) Pub. No.: US 2009/0202798 A1
(43) Pub. Date: Aug. 13, 2009

(54) Phthalocyanines and Their Use in Ink-Jet Printing

(76) Inventor: Prakash Patel, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 12/304,304

(22) PCT Filed: Jun. 12, 2007
(86) PCT No.: PCT/GB07/02148

§ 371 Date: Dec. 11, 2008

(30) Foreign Application Priority Data
Jun. 14, 2006 (GB) 0611764.2

(51) Int. Cl. C09D 11/00; B05D 5/00; B44C 5/04

(52) U.S. Cl. 428/211.1; 106/31.47; 540/126; 427/256; 428/195.1

(57) ABSTRACT

A mixture of dyes of Formula (1) and salts thereof:

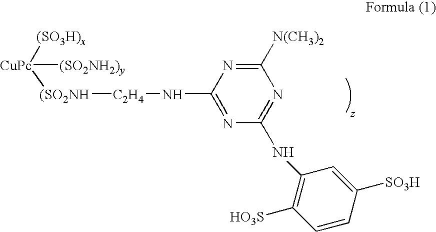

wherein:
Pc represents a phthalocyanine nucleus of formula

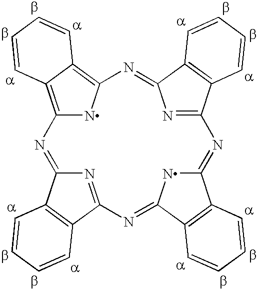

x is 1 to 2;
y is 0.1 to 2.9;
z is 0.1 to 1;
the sum of (x+y+z) is 2 to 4; and
   the substituents, represented by x, y and z, are only attached to a β position on the phthalocyanine ring and the dye s are free from fibre reactive groups. Also novel compositions and inkjet printer inks, processes and cartridges.

This invention relates to dyes, compositions and inks, to printing processes, to printed substrates and to ink-jet printer cartridges.

Ink-jet printing is a non-impact printing technique in which droplets of ink are ejected through a fine nozzle onto a substrate without bringing the nozzle into contact with the substrate.

Colour ink-jet printers typically use four different coloured inks; magenta, yellow, cyan, and black. Colours other than these may be obtained using differing combinations of these inks. Thus, for optimum print quality, the colourants used must be able to form an ink with a specific hue. This can be achieved by mixing colourants but is advantageously achieved by used a single colourant with the exact hue required.

While ink-et printers have many advantages over other forms of printing and image development there are still technical challenges to be addressed. For example, there are the contradictory requirements of providing ink colorants that are soluble in the ink medium and yet do not run or smudge excessively when printed on paper. The inks need to dry quickly to avoid sheets sticking together after they have been printed, but they should not form a crust over the tiny nozzle used in the printer. Storage stability is also important to avoid particle formation that could block the tiny nozzles used in the printer especially since consumers can keep an ink-jet ink cartridge for several months.

With the advent of high-resolution digital cameras and ink-jet printers it is becoming increasingly common for consumers to print off photographs using an ink-jet printer. This avoids the expense and inconvenience of conventional silver halide photography and provides a print quickly and conveniently. However this use of ink-jet printers requires that the prints should display an outstanding fastness to light and common oxidising gases such as ozone. Photographs, once printed, are often kept on display for years and it has been found that even apparently small changes in the light and ozone fastness of a print in a test systems can correlate to a significant improvement in the fastness of the image in real life.

Most cyan colorants used in ink-jet printing are based on phthalocyanines and problems of fading and shade change on exposure to light and contact with ozone are particularly acute with dyes of this class.

Phthalocyanines bearing sulfonate and sulfonamide substituents have found particular utility in ink-jet printing. These dyes are usually made by sulfonating a phthalocyanine pigment followed by chlorination and then amination/amidation, the resultant product carries sulfo and sulfonamide/substituted sulfonamide substituents in any susceptible position (for example see Schofield, J and Asaf, M in Journal of Chromatography, 1997, 770, pp 345-348).

However we have found that certain phthalocyanines substituted only in the β-position display advantageous properties when used in ink-jet printing.

The present invention provides a mixture of dyes of Formula (1) and salts thereof

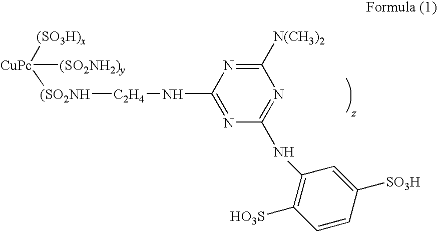

wherein:

Pc represents a phthalocyanine nucleus of formula

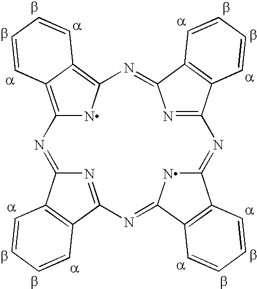

x is 1 to 2;

y is 0.1 to 2.9;

z is 0.1 to 1;

the sum of (x+y+z) is 2 to 4; and

the substituents, represented by x, y and z, are only attached to a β position on the phthalocyanine ring.

The sum of (x+y+z) is preferably 3 to 4, more preferably the sum of (x+y+z) is 4.

The mixture of dyes of Formula (I) are preferably prepared by a process comprising cyclisation of a β-substituted phthalic acid or analogue thereof. Preferred β-substituted phthalic acid analogues include phthalonitrile, iminoisoindoline, phthalic anhydride, phthalimide and phthalamide or mixtures thereof.

The cyclisation reaction may be carried out in the presence of a suitable source of ammonia (if required), and (if required) a suitable metal salt, for example CuCl₂, and a base such as 1,8-diazabicyclo[5.4.0]undec-7-ene (DBU) followed by, if required, further synthetic steps, for example, chlorination and then amination/amidation.

The total amount of x+y+z may be controlled by varying the degree and ratio of substituted phthalic acid or analogue thereof to unsubstituted phthalic acid or analogue thereof. Thus, when mono-substituted phthalic acid or analogue thereof is used in the cyclisation reaction then x+y+z is 4.

In a preferred synthetic preparation of phthalocyanine dyes of Formula (I) the phthalocyanine ring is prepared by the cyclisation of 4-sulfophthalic acid, preferably to phthalocyanine β-tetrasulfonic acid.

When a phthalocyanine β-sulfonic acid is an intermediate in a route to dyes of Formula (I) it may be chlorinated by reacting with any suitable chlorinating agent.

Chlorination is preferably carried out by treating the phthalocyanine β-sulfonic acid with chlorosulfonic acid preferably in the presence of an acid halide such as thionyl chloride, sulfuryl chloride, phosphorous pentachloride, phosphorous oxychloride or phosphorous trichloride.

The —SO₂Cl substituent, so formed, on the phthalocyanine ring is then further reacted with ammonia and (either sequentially or at the same time) a compound of formula:

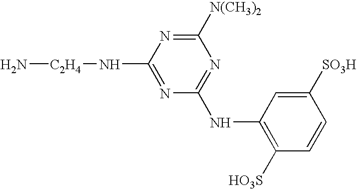

or with ammonia and (either sequentially or at the same time) ethylene diamine, the product of which can then be reacted with cyanuric chloride and then with dimethylamine and 2,5-disulfoaniline, either singly or at the same time.

A skilled person will appreciate that the product of these reactions will be a disperse mixture and so the values of x, y and z will represent an average of the groups present in the mixture,

This reaction yields a mixture of phthalocyanine dyes of Formula (1),

The dyes of Formula (1) are preferably free from substituents, other than H. in the α-position of the phthalocyanine ring.

The mixture of dyes of Formula (1) have attractive, strong cyan shades and are valuable colorants for use in the preparation of ink-jet printing inks. They benefit from a good balance of solubility, storage stability and fastness to water, ozone and light.

Acid or basic groups on the dyes of Formula (1), particularly acid groups, are preferably in the form of a salt. Thus, the Formulae shown herein include the dyes in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts. Dyes of Formula (1) may be converted into a salt using known techniques.

The dyes of Formula (1) may exist in tautomeric forms other than those shown in this specification. These tautomers are included within the scope of the present invention.

According to a second aspect of the present invention there is provided a composition comprising a mixture of dyes of Formula (1) as described in the first aspect of the invention and a liquid medium.

Preferred compositions according to the second aspect of the invention comprise:
(a) from 0.01 to 30 parts of a mixture of dyes of Formula (1) as described in the first aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts by weight. The number of parts of component (b) is preferably from 80 to 99.9, more preferably from 85 to 99.5 and especially from 95 to 99 parts by weight.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration cyan ink, a low concentration cyan ink or both a high concentration and a low concentration ink. In the latter case this can lead to improvements in the resolution and quality of printed images, Thus the present invention also provides a composition (preferably an ink) where component (a) is present in an amount of 2.5 to 7 parts more preferably 2.5 to 5 pads (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide and sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Examples of further suitable liquid media comprising a mixture of water and one or more organic solvents are described in U.S. Pat. No. 4,963,189. U.S. Pat. No. 4,703,113, U.S. Pat. No. 4,626,284 and EP425,150A,

When the liquid medium comprises organic solvent free from water, (i.e. less than 1% water by weight) the solvent preferably has a boiling point of from 300 to 200° C. more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the mixture of phthalocyanine dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties. Examples of such colorants include C.I. Direct Yellow 86, 132, 142 and 173; C.I. Direct Blue 307; C.I. Food Black 2; C.I. Direct Black 168 and 195; and C.I. Acid Yellow 23.

It is preferred that the composition according to the invention is ink suitable for use in an ink-jet printer. Ink suitable for use in an ink-jet printer is ink which is able to repeatedly fire through an ink-jet printing head without causing blockage of the fine nozzles.

Ink suitable for use in an ink-jet printer preferably has a viscosity of less than 20 cP, more preferably less than 10 cP, especially less than 5 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a dye of Formula (1) or any other colourant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

A third aspect of the invention provides a process for forming an image on a substrate comprising applying ink suitable for use in an ink-jet printer, according to the second aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain or treated papers which may have an acid, alkaline or neutral character. Glossy papers are especially preferred.

A fourth aspect of the present invention provides a material preferably paper, plastic, a textile, metal or glass, more preferably paper, an overhead projector slide or a textile material, especially paper more especially plain, coated or treated papers printed with a mixture of dyes as described in the first aspect of the invention, a composition according to the second aspect of the invention or by means of a process according to the third aspect of the invention.

It is especially preferred that the printed material of the fourth aspect of the invention is a photograph printed using a process according to the third aspect of the invention.

A fifth aspect of the present invention provides an ink-jet printer cartridge comprising a chamber and an ink suitable for use in an ink-jet printer wherein the ink is in the chamber and the ink is as defined in the second aspect of the present invention. The cartridge may contain a high concentration ink and a low concentration ink, as described in the second aspect of the invention, in different chambers.

The invention is further illustrated by the following Examples in which all parts and percentages are by weight unless otherwise stated.

### EXAMPLE 1

### Preparation of a mixture of dyes of Formula (I) wherein x is 1.8, y is 1.7 and z is 0.5

### Stage 1—Preparation of β-Substituted Copper Phthalocyanine Tetra Sulfonic Acid

Potassium 4-sulfophthalic acid (56.8 g), urea (120g), CuCl₂ (6.9 g), ammonium molybdate (1.2 g) and 1,8-diazabicyclo[5.4.0]undec-7-ene (DBU) (7.5 g) were mixed in a reaction vessel. The mixture was then warmed in stages (130° C./30 minutes, 150° C./30 minutes, 180° C./30 minutes, 220° C.) over 2 hours and the melt which formed was stirred at 220° C. for a further 2 hours. The solid that formed was extracted 4 times with hot water (4×200 ml) and the extract was filtered to remove insoluble material. The resultant filtrate was stirred at between 60° C.-70° C. and then sufficient NaCl was added to give a 7% salt solution. Stirring was continued and the solid that precipitated was filtered, washed with a 10% salt solution (200 ml) and pulled dry by vacuum. The resultant damp solid (77.6 g) was slurried in acetone, filtered and dried first at room temperature and then at 50° C.

This material may be further purified by “acid pasting”. This process involves slurry washing the material prepared above in sulfuric acid and then drowning out into water and precipitating with sodium chloride to give the sodium salt.

### Stage 2

### Preparation of β-Substituted Copper Phthalocyanine Sulfonyl Chloride:

Chlorosulfonic acid (68 molar equivalents), thionyl chloride (40 molar equivalents) and the acid pasted sodium salt of β-substituted copper phthalocyanine tetra sulfonic acid (1 molar equivalent), which may be prepared as described in stage 1, were mixed in a reaction vessel. This reaction mixture was warmed to 120° C. and kept at this temperature, with stirring for 4 hours. At the end of this time the reaction-melt was cooled.

### Stage 3

### Preparation of the Triazinyl Amine

2,5-Disulfoaniline (13.8 g) was dissolved in water with sodium hydroxide solution at pH7 and added dropwise to a slurry of cyanuric chloride (9.28 g) in water (200 ml) and calsolene oil (few drops) at pH 5 to 6 and 5° C. The pH of the reaction was maintained by the addition of dilute sodium hydroxide. After 2 hours the pH was raised to 7 and the reaction was left at 25° C. for 0.5 hours and then filtered. Dimethylamine (40% strength) (6.3 ml) was added to the filtrate, the pH was raised to pH 8.5 to 9 and the reaction was help at 25° C. for 2 hours. The reaction was then stirred for 1 hour at 60° C. and then for 1 hour 80° C. maintaining the pH at pH 9-10. The reaction was allowed to cool to room temperature overnight. The next day ethylene diamine (33 ml) was added and the reaction was heated at 80° C. for 2 hours. The resultant product was isolated by concentrating the reaction mixture to low volume (200 ml), adding salt (20 g) and lowering the pH to 1 with concentrated hydrochloric acid. The precipitated solid was filtered and washed with 20% sodium chloride solution (50 ml). The precipitate was stirred in a mixture of methanol (170 ml) and water (9 ml) at room temperature and then at 60° C. for 1 hour, allowed to cool and filtered, washed with methanol (25 ml) and dried to give the required product as a white solid (18.5 g),

### Stage 4

### Preparation of the Title Dyes

The phthalocyanine sulfonyl chloride paste from stage 2 was added to a stirred mixture of water containing 6 molar equivalents of ammonia and 0.7 molar equivalents of the triazinyl amine prepared in stage 3 at 0 to 5° C. The pH was then raised to 9 to 10 via the addition of dilute lithium hydroxide, and held at 0 to 5° C. for 30 minutes before heating to 40 to 42° C. while maintaining the pH at about 10. The reaction mixture was then left held overnight at 40° C. and pH10 to 11 to complete the reaction. The resultant solution was then passed over a 50K Dalton membrane to remove any salts present. The solution was then oven dried to give the final product,

### EXAMPLE 2

### Preparation of a mixture of dyes of Formula (1) wherein x is 1.8, y is 1.6 and z is 0.6

Example 2 was prepared as described above for Example 1 except that in stage 4 1.0 molar equivalents of the triazinyl amine prepared in stage 3 was used.

### Comparative Dye

Comparative Dye 1 was C.I. Direct Blue 199 obtained as Pro-jet® Cyan 1 from Fujifilm Imaging Colorants Ltd, as supplied this is a compound of Formula:

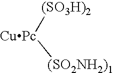

C.I. Direct Blue 199 is the most widely used cyan ink-jet dye.

### Ink and Ink-Jet Printing

Ink was prepared from the dyes of Examples 1 and 2 and the Comparative Dye by dissolving 3 g of the dye in 97 ml of a liquid medium consisting of 7 parts 2-pyrrolidone; 7 parts diethylene glycol; 7 parts ethylene glycol; 1 part Surfynol® 465; 0.2 parts Tris buffer and the balance deionised water and adjusting the pH to between pH 8 to 8.5 with sodium hydroxide. Surfynol® 465 is a surfactant from Air Products.

### Ink-Jet Printing

Ink, prepared as described above, was filtered through a 0.45 micron nylon filter and then incorporated into an empty print cartridge using a syringe.

These inks were the printed on to the following media:

Epson Ultra Premium Glossy Photo Paper (SEC PM); and

Canon Premium PR101Photo Paper (PR101).

### Print Evaluation

Prints, formed by ink-jet printing, were tested for ozone fastness by exposure to 5 ppm ozone at 25° C., 50% relative humidity, for 24 hrs in a Hampden 903 Ozone cabinet. Fastness of the printed ink to ozone was judged by the difference in the optical density before and after exposure to ozone.

Light-fastness of the printed image were assessed by fading the printed image in an Atlas Ci5000 Weatherometer for 100 hours and then measuring the change in the optical density.

Optical density measurements were performed using a Gretag spectrolino spectrophotometer set to the following parameters

| | |
|---|---|
| Measuring Geometry | 0°/45° |
| Spectral Range | 380-730 nm |
| Spectral Interval | 10 nm |
| Illuminant | D65 |
| Observer | 2° (CIE 1931) |
| Density | Ansi A |
| External Filler | None |

Light and Ozone fastness were assessed by the percentage change in the optical density of the print, where a lower figure indicates higher fastness, and the degree of fade. The degree of fade is expressed as ΔE and a lower figure indicates higher light fastness. ΔE is defined as the overall change in the CIE colour co-ordinates L, a, b of the print and is expressed by the equation ΔE=(ΔL²+Δa²+Δb²)^{0.5}.

| | | | |
|---|---|---|---|
| | % OD | | % OD |
| ΔE | Loss | ΔE | Loss |
| SEC PM | SEC PM | PR101 | PR101 |

Light Fastness

| | | | | |
|---|---|---|---|---|
| Ink 1 | 4 | 3 | 8 | 13 |
| Ink 2 | 5 | 5 | 8 | 12 |
| Comparative | 8 | 17 | 14 | 27 |
| Ink | | | | |

Ozone Fastness

| | | | | |
|---|---|---|---|---|
| Ink 1 | 6 | 9 | 3 | 7 |
| Ink 2 | 5 | 9 | 7 | 12 |
| Comparative | 32 | 56 | 47 | 69 |
| Ink | | | | |

Clearly dyes according to the present invention display an enhanced ozone fastness and an equivalent or superior light fastness compared to the market leading cyan dye.

### Further Inks

The inks described in Tables A and B may be prepared from the mixture of dyes of Example 1, Numbers quoted refer to the number of parts of the relevant ingredient and all parts are by weight. The inks may be applied to paper by ink-jet printing

The following abbreviations are used in Tables A and B:

PG=propylene glycol

DEG=diethylene glycol

NMP=N-methylpyrrolidone

DMK=dimethylketone

IPA=isopropanol

MeOH=methanol

2P=2-pyrrolidone

MIBK=methylisobutyl ketone

P12=propane-1,2-diol

BDL butane-2,3-diol

CET=cetyl ammonium bromide

PHO=Na₂HPO₄ and

TBT=tertiary butanol

TDG=thiodiglycol

TABLE A

| Dye | | | | | | | Na | | | | |
|---|---|---|---|---|---|---|---|---|---|---|---|
| Content | Water | PG | DEG | NMP | DMK | NaOH | Stearate | IPA | MEOH | 2P | MIBK |
| 2.0 | 80 | 5 | | 6 | 4 | | | | | 5 | |
| 3.0 | 90 | | 5 | 5 | | 0.2 | | | | | |
| 10.0 | 85 | 3 | | 3 | 3 | | | | 5 | 1 | |
| 2.1 | 91 | | 8 | | | | | | | | 1 |
| 3.1 | 86 | 5 | | | | | 0.2 | 4 | | | 5 |
| 1.1 | 81 | | | 9 | | 0.5 | 0.5 | | | 9 | |
| 2.5 | 60 | 4 | 15 | 3 | 3 | | | 6 | 10 | 5 | 4 |
| 5 | 65 | | 20 | | | | | 10 | | | |
| 2.4 | 75 | 5 | 4 | | 5 | | | | 6 | | 5 |
| 4.1 | 80 | 3 | 5 | 2 | 10 | | 0.3 | | | | |
| 3.2 | 65 | | 5 | 4 | 6 | | | 5 | 4 | 6 | 5 |
| 5.1 | 96 | | | | | | | | 4 | | |
| 10.8 | 90 | 5 | | | | | | 5 | | | |
| 10.0 | 80 | 2 | 6 | 2 | 5 | | | 1 | | 4 | |
| 1.8 | 80 | | 5 | | | | | | | 15 | |
| 2.6 | 84 | | | 11 | | | | | | 5 | |
| 3.3 | 80 | 2 | | | 10 | | | | 2 | | 6 |
| 12.0 | 90 | | | | 7 | 0.3 | | 3 | | | |
| 5.4 | 69 | 2 | 20 | 2 | 1 | | | | | 3 | 3 |
| 6.0 | 91 | | | 4 | | | | | | 5 | |

TABLE B

| Dye | | | | | | | | | | | |
|---|---|---|---|---|---|---|---|---|---|---|---|
| Content | Water | PG | DEG | NMP | CET | TBT | TDG | BDL | PHO | 2P | PI2 |
| 3.0 | 80 | 15 | | | 0.2 | | | | | 5 | |
| 9.0 | 90 | | 5 | | | | | | 1.2 | | 5 |
| 1.5 | 85 | 5 | 5 | | 0.15 | 5.0 | 0.2 | | | | |
| 2.5 | 90 | | 6 | 4 | | | | | 0.12 | | |
| 3.1 | 82 | 4 | 8 | | 0.3 | | | | | | 6 |
| 0.9 | 85 | | 10 | | | | | 5 | 0.2 | | |
| 8.0 | 90 | | 5 | 5 | | | 0.3 | | | | |
| 4.0 | 70 | | 10 | 4 | | | | 1 | | 4 | 11 |
| 2.2 | 75 | 4 | 10 | 3 | | | | 2 | | 6 | |
| 10.0 | 91 | | | 6 | | | | | | 3 | |
| 9.0 | 76 | | 9 | 7 | | 3.0 | | | 0.95 | 5 | |
| 5.0 | 78 | 5 | 11 | | | | | | | 6 | |
| 5.4 | 86 | | | 7 | | | | | | 7 | |
| 2.1 | 70 | 5 | 5 | 5 | 0.1 | 0.2 | 0.1 | 5 | 0.1 | 5 | |
| 2.0 | 90 | | 10 | | | | | | | | |
| 2 | 88 | | | | | | 10 | | | | |
| 5 | 78 | | | 5 | | | 12 | | | 5 | |
| 8 | 70 | 2 | | 8 | | | 15 | | | 5 | |
| 10 | 80 | | | | | | 8 | | | 12 | |
| 10 | 80 | | 10 | | | | | | | | |

1. A mixture of dyes of Formula (1) and salts thereof: 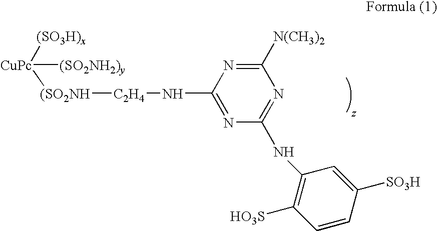
wherein:
Pc represents a phthalocyanine nucleus of formula 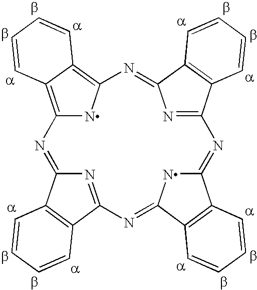
x is 1 to 2;
y is 0.1 to 2.9;
z is 0.1 to 1;
the sum of (x+y+z) is 2 to 4; and
the substituents, represented by x, y and z, are only attached to a β position on the phthalocyanine ring.

2. A mixture of dyes according to claim 1 wherein the sum of (x+y+z) is 4.

3. A mixture of dyes according to claim 1 prepared by a process comprising cyclisation of a β-substituted phthalic acid or analogue thereof.

4. A composition comprising a mixture of dyes of Formula (1) as described in claim 1 and a liquid medium.

5. A composition according to claim 4 which comprises:
(a) from 0.01 to 30 parts of a mixture of dyes of Formula (1) as described in any one of claims 1 to 12, and
(b) from 70 to 99.99 parts of a liquid medium;
wherein all parts are by weight.

6. A composition according to claim 4 which is ink suitable for use in an ink-jet printer.

7. A process for forming an image on a substrate comprising applying ink according to claim 6 thereto by means of an ink-jet printer.

8. A material printed by means of a process according to claim 7.

9. A material according to claim 8 which is a photograph.

10. An ink-jet printer cartridge comprising a chamber and an ink according to claim 6 wherein the ink is in the chamber.
